(19) United States
(12) Patent Application Publication
(10) Pub. No.: US 2019/0316909 A1
(43) Pub. Date: Oct. 17, 2019

(54) Estimating Aircraft Taxi Times

(71) Applicant: PASSUR Aerospace, Inc., Stamford, CT (US)

(72) Inventors: Thomas White, Stamford, CT (US); Harshitha Venkata, Stamford, CT (US); Priyadharshini Krishnamurthy, Stamford, CT (US); Madhuri Madhusudan, Stamford, CT (US); Matthew Marcella, Stamford, CT (US)

(21) Appl. No.: 15/952,914

(22) Filed: Apr. 13, 2018

(51) Int. Cl. G01C 21/20; G06N 5/02

(52) U.S. Cl. CPC G01C 21/20; G06N 5/02

(57) ABSTRACT

A device, system, and method estimate aircraft taxi times. The method includes receiving a request for a taxi estimate, the request having request values for factors. The method includes determining an interdependency among the factors based on information entropy and information gain. The method includes generating a decision tree based on the factors and the interdependency, each factor of the decision tree having a corresponding threshold value. The method includes estimating the taxi estimate based on traversing a path through the decision tree using the request values until a node is reached, the node indicated the taxi estimate.

### BACKGROUND INFORMATION

When an aircraft travels from a first location to a second location, there may be a plurality of different stages that the aircraft goes through. For example, there may be an ON phase, an IN phase, an OFF phase, an OUT phase, and a transit phase. The ON phase may be when the aircraft lands on a runway at a location; the IN phase may be when the aircraft reaches a gate after the ON stage; the OUT phase may be when the aircraft leaves the gate; the OFF phase may be when the aircraft takes off the runway; and the transit phase may be when the aircraft is traveling to another destination after the OFF phase and before an ensuing ON phase. As those skilled in the art will understand, before, after, and during each of these phases, there may be one or more stages. For example, there may be a taxi time for the aircraft between the ON phase and the IN phase. In another example, there may be another taxi time for the aircraft between the OFF phase and the OUT phase.

An estimated time of arrival (ETA) is a measure of when the aircraft is expected to be at a particular position. For example, for an aircraft traveling from the first location to the second location, there may be an ON ETA for when the aircraft lands on the runway at an airport of the second location. In this manner, there may be various ETAs that are used by various entities such as an airline associated with the aircraft, an airport at the first and/or second location, and another interested entity such as a traveler on the aircraft, a person associated with the traveler, an owner of cargo on the aircraft, etc. The ETA information may be used to inform the entities for proper actions to be taken or to schedule/update expected events. For example, entities associated with passengers or people interested in when a passenger lands at a target destination may use the information to plan a pickup. In another example, an airline entity may use the ETA information to, for example, schedule gate employees, ensure that a gate is available for an incoming flight, etc. One type of ETA may be the taxi times (e.g., between ON to IN phases, between OFF and OUT phases, etc.) that may affect the scheduling of events. Thus, knowledge of accurate taxi times may provide valuable information to interested entities.

There are various conventional systems that may be configured to determine taxi times of aircraft. However, these estimation features that are provided for taxi times may have associated drawbacks for their use. For example, a look up table (LUT) method may be created to estimate taxi times. However, the LUT method may succumb to a high dimensionality where more factors being added may cause the data set to become extremely sparse resulting in no matching samples. In another example, the LUT method may treat factors equally when, in reality, the factors may have unequal weight or have varying importance. Accordingly, with high dimensionality, an estimate for taxi times may be unavailable while, with imbalanced factors, an estimate for taxi times may be biased or inaccurate.

### SUMMARY

The exemplary embodiments are directed to a method, comprising: at an estimation server: receiving a request to estimate a time of arrival for an aircraft from a first position to a second position, the request having a plurality of request values for factors associated with the request, the factors being characteristics associated with the time of arrival; determining an interdependency among the factors based on information entropy and information gain, the information entropy indicating a disorder measurement in a historical data set corresponding to the factors, the information gain indicating a mutual measurement of the factors based on the historical data set; generating a decision tree based on the factors and the interdependency, a first one of the factors being at a first, highest level of the decision tree, the first factor in the decision tree having a first threshold value, at least one second one of the factors being at a second, lower level of the decision tree, the second factor in the decision tree having a second threshold value; and estimating the time of arrival based on traversing a path through the decision tree using the request values until a node is reached, the node indicated an estimated time of arrival.

The exemplary embodiments are directed to an estimation server, comprising: a transceiver configured to receive a request to estimate a time of arrival for an aircraft from a first position to a second position, the request having a plurality of request values for factors associated with the request, the factors being characteristics associated with the time of arrival, the transceiver also configured to receive a historical data set; and a processor determining an interdependency among the factors based on information entropy and information gain, the information entropy indicating a disorder measurement in a historical data set corresponding to the factors, the information gain indicating a mutual measurement of the factors based on the historical data set, the processor generating a decision tree based on the factors and the interdependency, a first one of the factors being at a first, highest level of the decision tree, the first factor in the decision tree having a first threshold value, at least one second one of the factors being at a second, lower level of the decision tree, the second factor in the decision tree having a second threshold value, the processor estimating the time of arrival based on traversing a path through the decision tree using the request values until a node is reached, the node indicated an estimated time of arrival.

The exemplary embodiments are directed to a non-transitory computer readable storage medium with an executable program stored thereon, wherein the program instructs a microprocessor to perform operations comprising: receiving a request to estimate a time of arrival for an aircraft from a first position to a second position, the request having a plurality of request values for factors associated with the request, the factors being characteristics associated with the time of arrival; determining an interdependency among the factors based on information entropy and information gain, the information entropy indicating a disorder measurement in a historical data set corresponding to the factors, the information gain indicating a mutual measurement of the factors based on the historical data set; generating a decision tree based on the factors and the interdependency, a first one of the factors being at a first, highest level of the decision tree, the first factor in the decision tree having a first threshold value, at least one second one of the factors being at a second, lower level of the decision tree, the second factor in the decision tree having a second threshold value; and estimating the time of arrival based on traversing a path through the decision tree using the request values until a node is reached, the node indicated an estimated time of arrival.

### BRIEF DESCRIPTION OF THE DRAWINGS

FIG. 1 shows an exemplary system for determining an estimated taxi time according to the exemplary embodiments.

FIG. 2 shows an exemplary estimation server of the system 100 according to the exemplary embodiments.

FIG. 3 shows an exemplary decision tree according to the exemplary embodiments.

FIG. 4 shows an exemplary method of determining an estimated taxi time according to the exemplary embodiments.

### DETAILED DESCRIPTION

The exemplary embodiments may be further understood with reference to the following description of the exemplary embodiments and the related appended drawings, wherein like elements are provided with the same reference numerals. The exemplary embodiments are related to a device, system, and method for estimating a taxi time of an aircraft after landing at an airport until reaching a gate. Specifically, the exemplary embodiments provide a mechanism that enables an estimated time of arrival (ETA) to be determined from an ON phase when the aircraft lands at an airport to an IN phase when the aircraft docks at a gate. As will be described in further detail below, the mechanism according to the exemplary embodiments utilizes information theory including information entropy and information gain to generate a decision tree with different factors as limbs until nodes are reached. Factors provided as inputs from a request may be used to navigate through the decision tree until a node is reached that indicates an appropriate estimated taxi time.

Initially, it is noted that the exemplary embodiments are described with regard to estimating a taxi time from the ON phase to the IN phase. However, the mechanism according to the exemplary embodiments determining this taxi time ETA is only exemplary. As those skilled in the art will understand, the exemplary embodiments may be utilized or modified to determine other types of taxi times or ETAs. In a first example, the taxi time ETA may also be from the OUT phase when the aircraft leaves the gate to the OFF phase when the aircraft takes off. In a second example, the ETA may be to a target position from a current position of any phase or stage that the aircraft may pass through. Thus, the ETA determined by the exemplary embodiments may be, for example, from a first transit position to a second transit position, from an ON phase to an OFF phase, etc. In a third example, the ETA may be a completion of a phase or stage. Thus, the ETA determined by the exemplary embodiments may be, for example, a deicing procedure, a passenger unloading, a passenger loading, etc. The exemplary embodiments may be configured to determine the ETA for any of these aspects including taxi times.

A common approach to estimate a taxi time is based on a look up table (LUT) method. The LUT method operates by creating a table of samples with all factors contributing to the taxi time represents columns where cells of a given column in the table contains the actual taxi time of a past flight. Then, for a given sample, an expected taxi time may be estimated by finding all rows where all of the factors match a given request. The estimated taxi time may be created by taking a mean or median for all matching samples.

Although the LUT method may provide one approach in determining an estimated taxi time, those skilled in the art will understand that there are several problems associated with the LUT method. In a first example, the LUT method suffers when there is high dimensionality. In machine learning, high dimensionality is used to describe a problem that occurs as more factors are added for consideration. Each factor (or generally referred to as a “variable”) creates a new dimension. The problem is that high dimensionality causes the data set to become extremely sparse. Thus, introducing high dimensionality, using the LUT method to search different tables returns no matching samples. Even when matching samples maybe returned, there may be only a few samples that may be biased or not represent a true mean/median for an estimated taxi time.

In a second example, the LUT method treats all factors equally. As not all factors have a probability of being equivalent when contributing to estimating a taxi time, the LUT method giving equal weight to the factors is unlikely to be optimal. In a third example, the LUT method does not look for combinations of factors where a combination may provide further insight into estimating a taxi time as opposed to only considering factors on an individual level. In a fourth example, the LUT method does not handle probability distributions that are not linear. Taxi time distributions are typically bell curves with a long tail of the longest taxi times. The LUT method has difficulty segmenting the long tails because of the rudimentary operations used in the LUT method.

The exemplary embodiments may determine an accurate estimation of an aircraft taxi time by utilizing formal methods based on Information Theory. Accordingly, the drawbacks associated with the commonly used LUT method may be addressed. Those skilled in the art will understand that Information Theory studies the discovery and exploration of mathematical laws that govern the behavior of data. Information Theory provides a theoretical basis for creating technologies in a wide range of industries including the development of the Internet (e.g., compression algorithms and efficient networking), Big Data, Machine Learning, space communications (e.g., Voyager spacecraft's ability to send signals from beyond the solar system to Earth using a 23 watt transmitter), mobile phone feasibility, quantum mechanics, etc. The exemplary embodiments adapt the principles of Information Theory to identify which factors in a particular order affect how a taxi time is determined. The exemplary embodiments described herein relates to the variety of data points used for determining an ON to IN taxi time of an aircraft and how Information Theory is used for mining a relatively large data set to maximize an accuracy of the estimate for the taxi time.

As will be described in further detail below, the mechanism according to the exemplary embodiments utilize Information Theory to generate a decision tree that orders different factors along limbs until a determination is made that a selected limb is to terminate in a node, the node indicating an estimated value such as a taxi time based on historical values. The exemplary embodiments may identify how the factors contribute to the taxi time and the manner in which factors interact with another under different circumstances that affect the estimated taxi time. In fact, the interaction of the factors may result in a single level of the decision tree having different factors. For example, a first path may be determined to have a higher contribution from a first factor over a second factor whereas a second path may be determined to have a higher contribution from the second factor over the first factor (or a third factor). The exemplary embodiments may further refine the decision tree utilizing an ensemble functionality in which a plurality of decision trees provide a weighted average such that the decision tree used in determining an estimated taxi time for a request from an entity may reduce errors in the estimation and provide a more accurate estimate.

As those skilled in the art will understand, providing an estimated taxi time to a requesting entity such as an aircraft pilot, corresponding airline, or airport personnel may be time sensitive. The requesting entity may request an estimated taxi time when the aircraft is to taxi in an immediate nature (e.g., within minutes of landing or the ON phase). In fact, even when the aircraft is in transit, the estimated taxi time may not be accorded any significant importance until the transit time is nearly completed and the aircraft is to land. For example, an estimated ON phase may fluctuate such that an estimated taxi time would also be subject to be influenced by this fluctuation. Accordingly, the requesting entity may request that the estimated taxi time be provided in this immediately preceding window of time (e.g., 5 minutes, 30 minutes, etc. before landing) or after having landed. The exemplary embodiments are configured to provide an estimated taxi time using the entropy based approach described in detail below in a timely manner to the requesting entity such that the requesting entity may utilize this information in coordinating corresponding efforts. In generating the decision tree that is created through the entropy based approach, historical information including a large amount of data (e.g., billions of data points) may be selectively incorporated by the exemplary embodiments in an efficient and timely manner.

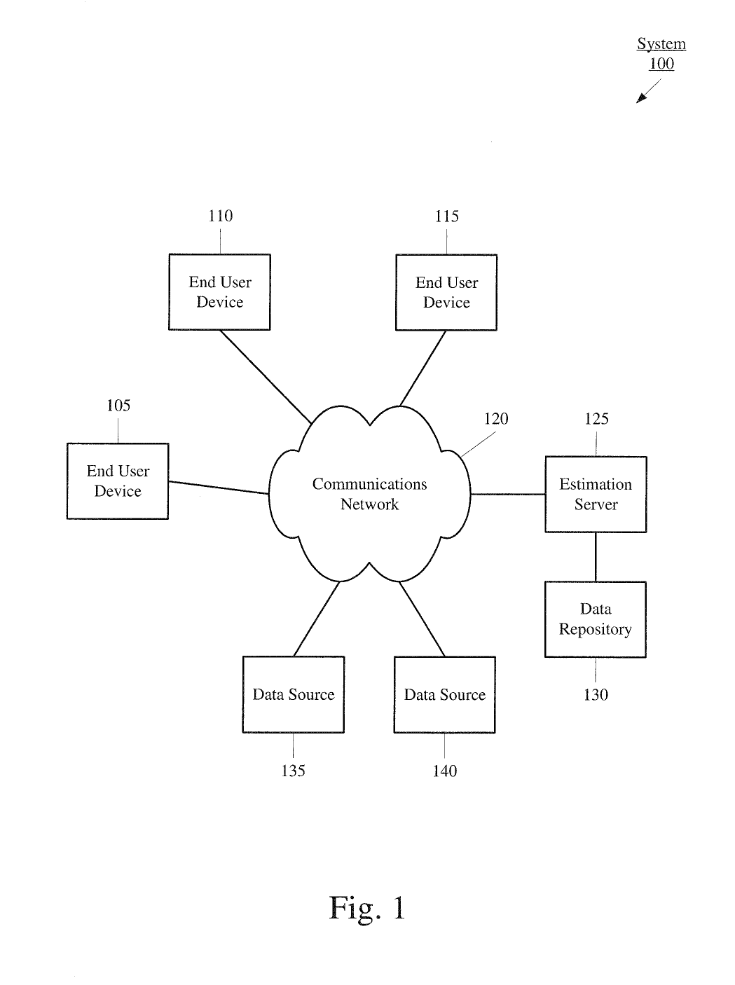

FIG. 1 shows a system 100 for determining an estimated taxi time according to the exemplary embodiments. The system 100 relates to communications between various components involved in providing an estimated taxi time from an ON phase to an IN phase based on a request including at least one factor and other factors that may be identified. The system 100 may be configured to generate one or more decision trees based on historical information having associated factors. The approach utilized by the exemplary embodiments understands that factors contributing to an estimated taxi time may be different in combination, order, etc. for a given scenario associated with a request. Thus, the interdependencies of the factors may be identified in generating the decision tree. In providing these features according to the exemplary embodiments, the system 100 may include a plurality of end user devices 105-115, a communications network 120, an estimation server 125, a data repository 130, and a plurality of data sources 135-140.

The end user devices 105-115 may be any electronic device associated with respective users utilizing the features of the exemplary embodiments. Accordingly, the end user devices 110-115 may include the necessary hardware, software, and/or firmware to provide any display or user interface for the features of the exemplary embodiments. For example, the end user devices 110-115 may be stationary devices (e.g., a desktop terminal) or mobile devices (e.g., a tablet, a laptop, etc.). The users may represent any entity that uses the exemplary embodiments such as an airline, an airport, an aircraft, a passenger, etc. In a particular example, the end user devices 105-115 may be associated with pilots or airline personnel to utilize the estimated taxi time in appropriate ways.

The communications network 120 may be configured to communicatively connect the various components of the system 100 to exchange data. The communications network 120 may represent any single or plurality of networks used by the components of the system 100 to communicate with one another. For example, if the end user device 105 is used at an airport, the communications network 120 may include a private network with which the end user device 120 may initially connect (e.g. an airport network). The private network may connect to a network of an Internet Service Provider (ISP) to connect to the Internet. Subsequently, through the Internet, a connection may be established to other electronic devices. For example, the estimation server 125 may be remote relative to the airport but may be connected to the Internet. Thus, the end user device 105 may be communicatively connected to the estimation server 125. In another example, if the end user device 110 is used at a residence, the communications network 120 may include a network of an ISP to connect to the network. It should be noted that the communications network 120 and all networks that may be included therein may be any type of network. For example, the communications network 120 may be a local area network (LAN), a wide area network (WAN), a virtual LAN (VLAN), a WiFi network, a HotSpot, a cellular network (e.g., 3G, 4G, Long Term Evolution (LTE), etc.), a cloud network, a wired form of these networks, a wireless form of these networks, a combined wired/wireless form of these networks, etc.

It is noted that the exemplary embodiments are described with regard to the end user devices 110-115 utilizing the features of the exemplary embodiments provided by the estimation server 125 using a connection via the communications network 120. For example, the exemplary embodiments may be implemented as a web service on a webpage hosted by the estimation server 125. In another example, the exemplary embodiments may be implemented as an application executed on the end user devices 105-115 but relies on a data exchange with the estimation server 125. However, this manner of providing the features of the exemplary embodiments is only exemplary. According to another exemplary embodiment, the features of the exemplary embodiments may be performed locally on the end user devices 105-115 using connections to various sources of information (as will be described in detail below). That is, the functionality of the estimation server 125 may be performed in a local manner.

The estimation server 125 may be configured to receive a request from one of the end user devices 105-115 and provide an estimated taxi time. Specifically, as noted above, the estimation server 125 may include functionalities associated with using the factors included in the request as well as other factors that may be identified to determine the estimated taxi time. As will be described in detail below, the estimation server 125 may utilize an ad hoc holistic approach in determining the estimated taxi time by considering the factors individually and by considering interdependencies that may exist among the factors. Accordingly, for a given scenario, select factors may be identified and an order of the select factors may be determined that affect the estimated taxi time.

The data repository 130 may be any component that enables the estimation server 125 to store data used in determining the ETA. As those skilled in the art will understand, the estimation server 125 may utilize a relatively large amount of data in determining the estimated taxi time such that the estimated taxi time may be determined as accurately as possible given the available historical information and factors of the request. Accordingly, the estimation server 125 may store data in the data repository 130 as data is being requested from the data sources 135-140. The data repository 130 may also be used to store data that is not immediately being used by the estimation server 125 in determining an estimated taxi time. For example, the estimation server 125 may manage data being stored in the data repository from the data sources 135-140 as a sliding window so that data that may be used in determining an estimated taxi time for a subsequent request may be readily available.

The data sources 135-140 may represent any source of information that the estimation server 125 may use in determining the ETA. Initially, it is noted that the data sources 135-140 being represented as two separate sources is only exemplary. The system 100 may include any number of sources from which the estimation server 125 may receive information. For example, at least one of the data sources 135-140 may represent any source upon which historical information may be received. In a first example of historical information, at least one of the data sources 135-140 may store time stamps associated with an aircraft corresponding to a respective position. In a second example of historical information, at least one of the data sources 135-140 may store map information (e.g., a layout of an airport, a layout of runways at the airport, etc.). In a third example of historical information, at least one of the data sources 135-140 may store historical weather information. Further types of historical information may include an aircraft type, a load factor, a gate, a runway, a filed route, a flown route, a density or congestion factor, a predictive sector loading, a region of interest, segment transit times, etc. In another example of information in the data sources 135-140, at least one of the data sources 135-140 may represent any source upon which live performance information may be received. It is noted that live performance information may relate to aircrafts or may also relate to current or predicted conditions. In a first example of the live performance information, at least one of the data sources 135-140 may store real-time information from passive and active radar systems as well as airport and airline information. In a second example of the live performance information, at least one of the data sources 135-140 may store weather forecasts. In a third example of the live performance information, at least one of the data sources 135-140 may store current runway conditions (e.g., construction areas, runway closings, etc.). Further types of live performance information may include a region of interest (e.g., a gate, a ramp, a taxiway, a deicing pad, a deicing and departure runway queue time, etc.) that may be defined by a geo-fence designed to capture activity in a specific geographical area, transit times, dwell times, an aircraft type, a filed route, flown route, a density or congestion factor, an actual sector loading, a region of interest, segment transit times (e.g., by aircraft, by previous flight activity including by similar type of aircraft, by the same route, by the same altitude, etc., etc.), etc.

In a particular implementation of the data sources 135-140, one of the data sources 135-140 may provide a data feed from a passive radar system and/or an active radar system. An exemplary passive radar system may be, for example, the PASSUR System sold by PASSUR Aerospace, Inc. of Stamford, Conn. An exemplary active radar system may be, for example, an FAA feed. The information provided by the active and/or passive radar systems may include target data points or positions for a particular aircraft. These target data points may include, for example, the time (e.g., UNIX time), the x-position, the y-position, altitude, x-velocity component, y-velocity component, z-velocity component, the speed, the flight number, the airline, the aircraft type, the tail number, etc.

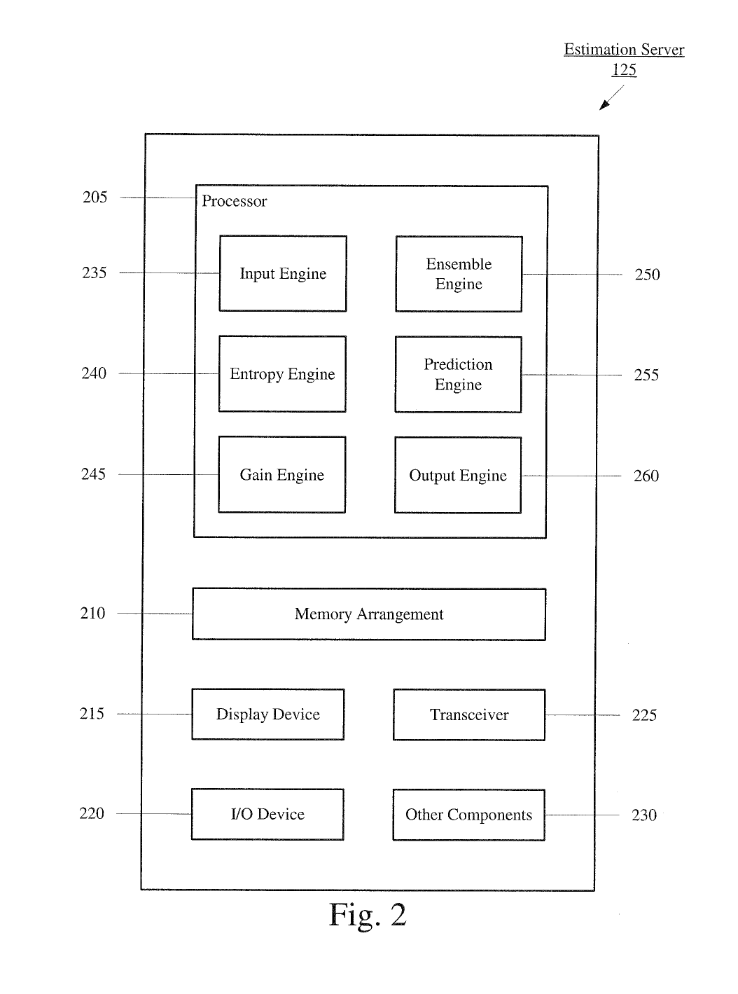

As noted above, the estimation server 125 may utilize historical information of taxi times and the various factors associated therewith and apply Information Theory to determine a decision tree used to determine an estimated taxi time for a given request. FIG. 2 shows the estimation server 125 of the system 100 according to the exemplary embodiments. The estimation server 125 may provide various functionalities in determining the estimated taxi time for an aircraft after landing at an airport and docking at a gate. Although the estimation server 125 is described as a network component (specifically a server), the estimation server 125 may be embodied in a variety of hardware components such as a portable device (e.g., a tablet, a smartphone, a laptop, etc.), a stationary device (e.g., a desktop terminal), incorporated into the end user devices 105-115, incorporated into a website service, incorporated as a cloud device, etc. The estimation server 125 may include a processor 205, a memory arrangement 210, a display device 215, an input and output (I/O) device 220, a transceiver 225, and other components 230 (e.g., an imager, an audio I/O device, a battery, a data acquisition device, ports to electrically connect the estimation server 125 to other electronic devices, etc.).

The processor 205 may be configured to execute a plurality of engines of the estimation server 125. The processor 205 may utilize a plurality of engines including an input engine 235, an entropy engine 240, a gain engine 245, an ensemble engine 250, a prediction 255, and an output engine 260. As will be described in further detail below, the input engine 235 may be configured to receive data from the other components of the system 100 such as the end user devices 105-115 (e.g., a request), the data repository 130, and the data sources 135-140 (e.g., historical information and live performance information). The entropy engine 240 may be configured to determine information entropy from the information upon which a decision tree is generated. The gain engine 245 may be configured to determine information gain from the information upon which a decision tree is generated. The ensemble engine 250 may be configured to generate one or more decision trees based on the outputs of the entropy engine 240 and the gain engine 245. The prediction engine 255 may be configured to determine a path along the decision tree based on the factors included in the request and other factors that may be identified to reach a node that indicates an estimated taxi time for the request. The output engine 260 may be configured to distribute the output of the prediction engine 255 to the requesting entity.

It should be noted that the above noted engines each being an application (e.g., a program) executed by the processor 205 is only exemplary. The functionality associated with the engines may also be represented as components of one or more multifunctional programs, a separate incorporated component of the estimation server 125 or may be a modular component coupled to the estimation server 125, e.g., an integrated circuit with or without firmware.

The memory 210 may be a hardware component configured to store data related to operations performed by the estimation server 125. Specifically, the memory 210 may store metadata used in determining interdependencies of factors used in generating a decision tree. The display device 215 may be a hardware component configured to show data to a user while the I/O device 220 may be a hardware component that enables the user to enter inputs. For example, an administrator of the estimation server 125 may maintain and update the functionalities of the estimation server 125 through user interfaces shown on the display device 215 with inputs entered with the I/O device 220. It should be noted that the display device 215 and the I/O device 220 may be separate components or integrated together such as a touchscreen. The transceiver 225 may be a hardware component configured to transmit and/or receive data via the communications network 120.

According to the exemplary embodiments, the estimation server 125 may determine an estimated taxi time for an aircraft from an ON phase to an IN phase. As will be described in further detail below, an entropy based approach may be used to determine a degree that a factor contributes to estimating the taxi time as well as an interdependency of factors that impacts how the taxi time is estimated, each path from a highest level factor to a lowest level factor having a respective impact of factors. Specifically, a decision tree may organize the factors with a selected factor being at the highest level and subsequent factors being at one or more lower levels. The selected factor at the highest level may be based on available factors associated with a given request. Each lower level may include one or more different subsequent factors that lead a decision in a respective path through the decision tree until a node or end is reached. A node may be generated for the decision tree based on various factors which will be described in further detail below. Furthermore, the estimation server 125 may generate a plurality of decision trees that are combined in a weighted fashion to form an overall decision tree that is used to navigate and find a path for a given request. The weighting of the decision trees may be based on, for example, random forests and a measure of importance to the overall decision tree which will be described in further detail below.

The input engine 235 may receive data from the other components of the system 100 such as the end user devices 105-115 (e.g., a request), the data repository 130, and the data sources 135-140 (e.g., historical information and live performance information). For example, the end user device 105 (e.g., an onboard computer on an aircraft) may transmit a request for an estimated taxi time upon landing to reach a gate. Accordingly, the input engine 235 may receive data from the end user devices 105-115. In another example, during the process of determining the estimated taxi time, the estimation server 125 may request data from the data sources 135-140 or from the end user device 105 (if further information is required). Accordingly, the input engine 235 may receive data from the data sources 135-140 corresponding to historical information and live performance information.

The input engine 235 may also be configured to analyze the request and identify factors included in the request. For example, the request may include identification information (e.g., an aircraft identification, an airport identification, an estimated landing time, etc.). The input engine 235 may include a functionality (e.g., parsing functionality) to identify the included factors in the request. The input engine 235 may also be configured to determine other factors that are not included in the request but may be associated with determining an estimated taxi time for the request. For example, the input engine 235 may receive manual entries from a user (e.g., an administrator, an airport scheduling personnel, etc.). The other factors may be a runway that is to be used, a particular path that a taxi is to be performed, etc. The input engine 235 may also be configured to automatically determine other factors. For example, the runway may also be determined based on the estimated landing time (e.g., the airport may be pre-configured to utilize select runways at certain times of the day). In this manner, the input engine 235 may identify the various factors that are to be used for the decision tree.

The factors may include, for example, time of day, day of a week, week of a year, a precipitation amount, a temperature, a visibility, an actual number of other departing aircraft on the tarmac, an expected number of other departing aircraft on the tarmac at the predicted arrival or landing time, an actual number of other arriving aircraft on the tarmac, an expected number of other arriving aircraft on the tarmac at the predicted arrival or landing time, an arrival runway, an arrival fix or standard terminal arrival route (STAR), an estimated departure clearance time (EDCT), a scheduled time of departure, an arrival terminal, an arrival gate, etc. As noted above, select ones of the factors may originate from various sources such as the data sources 135-140. For example, some factors may come from government sources (e.g., EDCT, arrival fix, STAR values, etc.). Other factors may come from both government and private sources such as weather related factors. Actual runways used for past flights may be determined by processing radar location data from flights and storing the information into a corresponding database. Predicted runways may come from a combination of flight plan information (e.g., arrival fix) and predicted runway configurations for each airport. The predicted runway information may come from a database of past runway usage at each airport based on predicted weather information as forecasted. As for other factors (e.g., time of day, day of the week, week of the year, etc.), these may be based on actual times of arrival of prior flights. These factors may give indications as to how busy an airport may be at certain times of the day, days of the week, and seasonal factors as indicated by week of the year.

The entropy engine 240 may determine information entropy from the information upon which a decision tree is generated. According to the exemplary embodiments, a concept in Information Theory that is modified and used is information entropy. As those skilled in the art will understand, information entropy is similar to entropy as defined in thermodynamics. Under Information Theory, information entropy is a measure of disorder in an information system. For the exemplary embodiments, information entropy is used to determine how various factors affect the taxi time from the ON phase to the IN phase (e.g., runway and gate, time of day, surface congestion, weather, season of year, etc.).

The exemplary embodiments utilize the principles of entropy to reduce the disorder of a data set with respect to taxi times and factors. The entropy equations (noted below) may provide a means to measure how factors influence taxi times. In addition, the exemplary embodiments utilize the principles of entropy to determine how the factors interact with each other and what combinations of factors (as well as in which order) should be combined to provide a greatest accuracy. For example, time of day may be important, but congestion may be more important. However, at certain airports, taxi times may be much longer late at night even though overall airport congestion is low at that time. Accordingly, the principles of entropy and the entropy equations may be used to determine these aspects.

As noted above, the exemplary embodiments may utilize entropy equations in determining information entropy and how factors interact with one another. For example, the exemplary embodiments may utilize the Bayes' Theorem:

p(s,r)=p(s|r)·p(r) (Equation 1)

The entropy equations may determine an entropy for a single factor S with the following:

$$H ( S ) = - {\sum }_{i} p ( {s}_{i} ) {log}_{2} p ( {s}_{i} ) \qquad ( Equation 2 )$$

The entropy equations may determine a joint entropy for two factors R and S with the following:

$$H ( R , S ) = - {\sum }_{i} {\sum }_{j} p ( {s}_{i} , {r}_{j} ) {log}_{2} p ( {s}_{i} , {r}_{i} ) \qquad ( Equation 3 )$$

The entropy equations may determine a conditional entropy of a first factor R given S or neuronal noise with the following:

$$H ( R \vert S ) = - {\sum }_{j} p ( {s}_{j} ) {\sum }_{i} p ( {r}_{i} \vert {s}_{j} ) {log}_{2} p ( {r}_{i} \vert {s}_{j} ) \qquad ( Equation 4 )$$

The entropy equations may determine a conditional entropy of a first factor S given R or neuronal noise with the following:

$$H ( R \vert S ) = - {\sum }_{j} p ( {r}_{j} ) {\sum }_{i} p ( {s}_{i} \vert {r}_{j} ) {log}_{2} p ( {s}_{i} \vert {r}_{j} ) \qquad ( Equation 5 )$$

The entropy equations may also utilize equivalent forms for average information with the following equations:

I(R,S)=H(R)−H(R|S) (Equation 6)

I(R,S)=H(S)−H(S|R) (Equation 7)

I(R,S)=H(R)+H(S)−H(R,S) (Equation 8)

The entropy engine 240 may be configured to utilize and/or modify the above entropy equations in determining the information entropy and combinations of factors that affect taxi times.

The gain engine 245 may determine information gain from the information upon which a decision tree is generated. The exemplary embodiments extend the use of entropy under Information Theory to provide another entropy based consideration—information gain. Those skilled in the art will understand that information gain measures how much one factor provides information about another factor. As noted above, the entropy engine 240 may introduce the concept of interaction and interdependency of factors in combination and order. The gain engine 245 may provide further information with regard to this aspect. For example, with regard to the estimating the taxi time from the ON phase to the IN phase the information gain may identify a degree to which a factor (e.g., time of day) influences taxi times. In this manner, information gain may be referred to as mutual information or how much information one random variable or factor indicates about another variable or factor. For example, in guessing a following letter in a sequence, if given the letter “Q”, then mutual information indicates that, based on probability, the next letter has a high likelihood of being the letter “U”. The gain engine 245 may apply this principle to the factors that are to be considered and/or known in estimating the taxi time.

Through the entropy engine 240 and the gain engine 245, the exemplary embodiments may utilize Information Theory to enable a measure of how well each factor and in what combination yields the most accurate results in estimating a taxi time associated with a given request (received via the input engine 235). The estimation server 125 may examine a significant amount of data (e.g., billions of data points) to determine which factors and in what combinations reduce the overall disorder in the data set. Again, entropy refers to a measure of disorder in the data set. Thus, the estimation server 125 may summarize every data point and corresponding taxi time. The estimation server 125 may select factors based on which factor reduces the disorder of the data set and the degree to which the reduction is made. In reducing the disorder, the gain engine 245 may determine the information gain and thus how much each factor contributes to segmenting taxi times into different time intervals. For example, some taxi times may be only three minutes while others may be thirty minutes. By measuring information entropy via the entropy engine 240 and information gain via the gain engine 245, the estimation server 125 may measure how well each factor performs in determining a proper taxi time interval.

The ensemble engine 250 may generate one or more decision trees based on the outputs of the entropy engine 240 and the gain engine 245. Initially, the manner in which the exemplary embodiments may generate a decision tree is described herein. However, as noted above and as will be described in further detail below, the exemplary embodiments may also utilize a random forest feature in which a plurality of decision trees are generated for an overall decision tree to be used. The above description with regard to the entropy engine 240 and the gain engine 245 illustrated how individual factors (e.g., time of day, runway identification, etc.) may be measured for information gain. Since no single factor may be a good indication of taxi time expectation, a decision tree may be used to combine the various factors in a particular combination. The decision tree may also be generated by determining an order of the factors and a precedence that is given to each factor. In this manner, the decision tree may be generated as a binary decision tree of factors from a highest level to lower levels until a node is reached.

An exemplary decision tree may have a top level decision tree or highest level factor. This factor may be one that has a highest contribution or effect on estimating a taxi time for a given request. For example, the factor may be a runway identification (e.g., 22R) at an airport that an aircraft has landed or will land. Thus, being a binary decision tree, all samples that match the selected factor (e.g., of the runway) may traverse down a first side of the tree (e.g., right side of the tree) while all other samples may traverse down the other side of the tree (e.g., left side of the tree). On a next level for a particular path from the prior level and assuming that a node is not determined to be used for the selected path from the prior level, an immediately following lower level may be a next ordered feature based on the path from the prior level. For example, for one of the selected paths, the first lower level may be time of day. In another example, for the other selected path, the first lower level may be weather. Thus, each branch of the tree may be independent of all other branches and each branch may choose its own factor that is likely to be different than other tree branches, even the ones at the same tree depth or level. These decisions of the factors for each level and the combination per path may be identified based on the information entropy and the information gain from the entropy engine 240 and the gain engine 245.

The ensemble engine 250 may be configured to then determine whether a particular path is to end and a node is to be created for a particular path of a branch in the decision tree. The node may contain the class or the final value which is the estimated taxi time for the exemplary embodiments. The ensemble engine 250 may utilize classification trees that are pruned to avoid over-fitting of the decision tree for a sample data set. The decision tree system provided by the ensemble engine 250 may use a combination of one or more criteria for determining if a path along the decision tree is to terminate with no further splitting and create a node. In a first example, a class distribution criteria may be used. The class distribution criteria may indicate that if a preponderance of the classes in the remaining samples of the data set for a path is only one class, then a node may be declared. In a second example, a number of samples may be used. The number of samples may indicate that if the samples remaining in the data set are less than a predetermined threshold (e.g., only 10 samples remaining), a node may be declared. The predetermined threshold may be determined in an ad hoc manner and after testing various values that achieve optimum results. In a third example, a maximum tree depth may be used. The maximum tree depth may indicate that if the decision tree grows beyond a declared maximum tree depth or a number of levels (e.g., 15 levels), then a node may be declared. The optimal tree depth may be calculated by running and rerunning the test samples and maintaining the tree depth values where the error is minimized. In a fourth example, a minimal error rate may be used. The minimal error rate may be akin to a cost complexity pruning which is a machine learning operation reducing a size of the decision tree through level removal that provides less than a predetermined amount of significance or effect in estimating the taxi time. Using the above operations, the ensemble engine 250 may stop splitting the decision tree for each path with a node if the accuracy is improved when the node is created. In effect, the ensemble engine 250 may use a brute force functionality that continually reruns the test data set for each node that is tested. In this way, a decision tree is produced that minimizes the overall error in the tree by pruning where improvements are made by performing these operations.

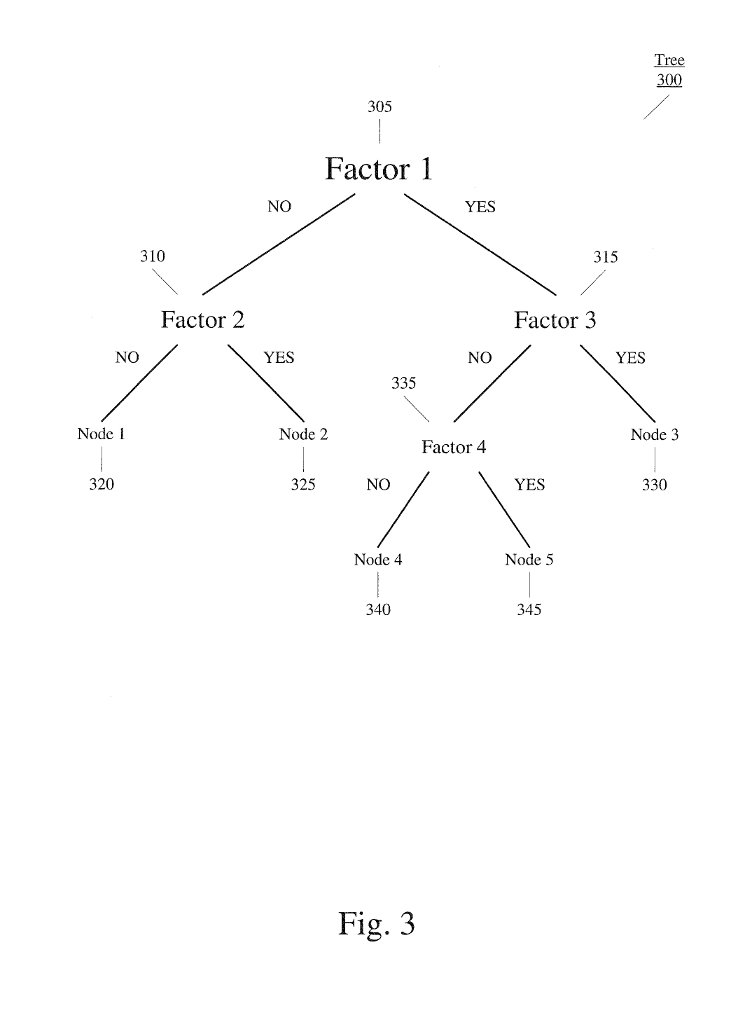

FIG. 3 shows a decision tree 300 according to the exemplary embodiments. The decision tree 300 shows how a highest level factor is selected and then how each subsequent level may end with a node or split to a lower level until a node is reached for each possible path along the decision tree 300. For illustrative purposes, the decision tree is only shown with four levels. However, those skilled in the art will understand that the decision tree 300 may have any number of levels where a maximum number of levels may be defined or forced using the above noted node creation criteria. As illustrated, the decision tree 300 may include a first, highest level including a factor 305. In a second, lower level, the factor 305 may branch into a factor 310 and a factor 315. In a third, lower level, the factor 310 may branch into a node 320 and a node 325 while the factor 315 may branch into a node 330 and a factor 335. Then, in a fourth, lower level, the factor 335 may branch into a node 340 and a node 345.

Returning to the estimation server 125 of FIG. 2, the prediction engine 255 may determine a path along the decision tree based on the factors included in the request and other factors that may be identified to reach a node that indicates an estimated taxi time for the request. Thus, when a decision tree such as the decision tree 300 has been generated, a request may be received (e.g., via the input engine 235) and factors associated therewith may be identified. It is noted that the decision tree 300 may have been generated based at least in part from the request and the associated factors. Thus, the decision tree 300 may have been generated after the request was received. The prediction engine 255 may then traverse the decision tree 300 along a path based on the associated factors until a node has been reached. In this manner, the prediction engine 255 may determine an estimated taxi time for the request using the decision tree 300.

Referring back to the decision tree 300 illustrated in FIG. 3, the prediction engine 255 may traverse through a path based on the factors of the request. For an unknown sample or request that is to be calculated for a prediction (e.g., an estimated taxi time), the decision tree 300 may be used to find the prediction. The process may start with the top node (e.g., the factor 305) and progress down the decision tree 300 based on the feature values that the unknown sample or request has. In an example, the request may have the following values: runway 22R, time of day of 8 am, day of week of 4 (e.g., out of 7 with Sunday being 1 and Saturday being 7), and weather precipitation value of 6 (e.g., out of 10 where 1 is little to no precipitation and 10 is substantially high amounts of precipitation).

Based on the tree values, the prediction engine 255 may determine a predicted value of the taxi time by traversing a path until a node is reached. Starting with the top value at the highest level, the first factor 305 may be a runway and whether the runway has a particular runway identification. Specifically, the first factor 305 may be whether the runway factor for the request is for runway 22R. Since the example request indicates that the runway is runway 22R for the first factor 305, there is match and the prediction engine 255 traverses down the right side of the decision tree 300 to the factor 315. At the second, lower level, through the factor 315, the second level feature may be time of day and whether the time of day is at least 10 am. In this instance, the time of day is 8 am and so the prediction engine 255 passes down the left side of the decision tree 300 since the criteria for the factor 315 is not matched. The prediction engine 255 thus reaches the factor 335 on the third, lower level. At the third, lower level, through the factor 335, the third level feature may be weather precipitation being at least a value of 4. In this instance, the weather precipitation is 6 and so the prediction engine 255 passes down the right side of the decision tree 300 since the criteria for the factor 335 has matched. By traversing down the right branch at the factor 335 in the third, lower level, the path leads not to a feature and a value but instead to a prediction as this branch leads to a node. Specifically, the node has a predicted class of 15 minutes for an estimated taxi time. Therefore, for the given request and the decision tree 300, the estimated taxi time may be returned by the prediction engine 255 as 15 minutes. In the same manner, for each flight, a value may be measured for each factor for that flight and, based on the nodes, a prediction of the taxi time may be made for each flight based on the current values of each feature and the decision tree that is generated for the flight and request.

Returning to the ensemble engine 255 of the estimation server 125 in FIG. 2, a further functionality that may be provided by the ensemble engine 255 is a random forest feature. The random forest feature may further improve an accuracy of estimating a taxi time through a plurality of decision trees being incorporated into an overall decision tree. The above described how generating a single decision tree may provide various benefits in estimating the taxi time. However, by generating a plurality of decision trees that contribute into the information entropy and information gain as well as the calculation of nodes in the overall decision tree, the estimated taxi times represented in the nodes may have a higher accuracy and reduce errors. Thus, the ensemble engine 255 may provide this feature where a plurality of decision trees are generated and aggregated into an overall decision tree for a given request and in estimating the taxi time.

A random forest is a collection of a plurality of decision trees. As described above, a decision tree is a tree-like model that analytically shows a hierarchical order of decisions and their consequences. Using different ways of learning a decision tree from a given set of historical observations or a data set (e.g., training data and their results), a homogeneity of a target variable within subsets of the data may be determined. The quality of branching for a decision tree is determined by applying these metrics to chosen subsets of data (e.g., gini index, information gain, etc.). Again, information gain may provide substantially valuable insight since it gives a relatively good estimate of determining which factors affect the taxi times (e.g., runway, weather, time of the day, etc.). Once a decision tree has been built, a value such as an estimated taxi time may be predicted based on the values of several input variables.

Decision Trees are transparent and relatively easy to interpret. By viewing the levels of the decision tree, the main factors affecting a target variable may be identified. For example, in the decision tree 300 of FIG. 3, it may be ascertained that the first factor 305 being a runway identification of runway 22R plays a very important role in predicting the taxi time at the corresponding airport for a given request.

While many learning models fail to describe non-linear relationships between factors, the decision tree used in the exemplary embodiments does not make assumptions in linearity and provides a more suitable method of estimating the taxi time. However, a single decision tree may run into certain drawbacks such as overfitting as a decision tree becomes more complex (e.g., reaching a maximum number of levels). Another drawback may be instability. That is, a small change in the input data of the request may, at times, cause a significant change in the results or the path to the estimated taxi time. Therefore, the ensemble engine 255 may utilize a random forest functionality as described herein.

In machine learning techniques, an ensemble method uses multiple learning algorithms to obtain a better performance. The random forest functionality is an ensemble method that constructs a plurality of decision trees while training and uses the output of each of these decision trees to predict the final class of the target variable by creating an overall decision tree.

The bias or over-fitting that may have been generated by a single decision tree may be overcome by using multiple decision trees in a random forest. In using the random forest, each of these decision trees are generated to be unique and shows a way to analyze the data or problem from a different perspective. Thus, each tree is learned by choosing a subset of input variables or factors randomly. For example, if taxi time predictions depend on runway, gates, time of the day, weather, and day of the week, the first tree may randomly select only the factors of runway and time of the day to perform a learning while the second tree may select weather and day of the week. The performance of a random forest is therefore affected by the maximum number of factors to choose randomly. Increasing the maximum number of factors improves the performance of the model and, at the same time, makes the decision tree complex and causes over-fitting. Accordingly, a balance is to be struck between the factors while choosing a value for a maximum number of factors. Therefore, the ensemble engine 255 in using the random forest functionality may build “weaker” decision trees individually and hence avoid over-fitting while simultaneously providing a combined result of each decision tree that provides a better estimate for taxi times.

The ensemble engine 255 may also be configured to determine the manner in which to combine the results of each of these individual decision trees. Similar to the LUT method, a standard approach is to determine the mode of all the classes predicted by each individual decision tree. The mode may sometimes fail as the number of decision trees in a random forest decreases. Another approach is to use a mean or average. However, an average may be skewed or biased by outlier class predictions. To improve the understanding of the relative importance of each individual decision tree, the ensemble engine 255 may utilize a measure of weighing the decision trees and a identifying a degree by which each decision tree contributes to the overall decision tree.

To predict taxi times, an approach using weighted decision trees provides increased accuracy relative to a mode or mean approach. With the weighted decision trees approach, a subset of the input data may be set aside to test the resulting trees (this input data being set aside referred to as “test data”). Every sample of the test data may be run on each decision tree of the random forest. For a test sample i, the corresponding classes predicted by each decision tree may be stored (e.g., in the data repository 130) where C1i may be for the first decision tree, C2i may be for the second tree, etc. Assuming the actual class/taxi time values of the ith test sample is Ti, the error of each kth decision tree for ith test sample may be determined as abs(Cki−Ti). The combined error of all test samples for the kth decision tree may be determined with Ek=Σabs(Cki−Ti) where the summation is over all the test samples.

A measure of how important an individual decision tree may then be determined. For a decision tree k, a large value of Ek implies that the decision tree is less accurate and is given a lower weight. To calculate the weights, reciprocals of Ek for each decision tree may be divided by the sum of reciprocals of all the decision trees. That is, the following may be used:

$${W}_{k} = \frac{\frac{1}{{E}_{k}}}{\frac{1}{{E}_{1}} + \frac{1}{{E}_{2}} + \frac{1}{{E}_{3}} + … \frac{1}{{E}_{n}}} ,$$

where n is number of decision trees. This provides a normalized weight for each decision tree, where a higher value of Wk implies the decision tree is more accurate. The combined predicted class/taxi time P is therefore determined with the following: P=(W₁C₁+W₂C₂+W₃C₃+ . . . WₙCₙ), where n is number of decision trees.

In utilizing the random forest functionality, the ensemble engine 255 may generate an overall decision tree to be used for the request that further reduces an error from using the LUT method or using only a single decision tree. The weighting approach for the decision trees further reduce this error so that each node in the overall decision tree has a higher accuracy such that the estimated taxi time that is returned by the prediction engine 255 may be provided with a higher confidence to the requesting entity that supplied the request.

Returning to the estimation server 125 in FIG. 2, the output engine 260 may distribute the output of the prediction engine 255 to the requesting entity. For example, when the features of the exemplary embodiments are embodied as an application in which a request is received from the end user devices 105-115, the output engine 260 may transmit the estimated taxi time to the requesting entity. In another example, when the features of the exemplary embodiments are embodied as a web service or display that is continuously updated, the output engine 260 may format the estimated taxi times that are determined for various “requests” or combination of factors in the display (e.g., in a table of all aircraft inbound or outbound from a specific location).

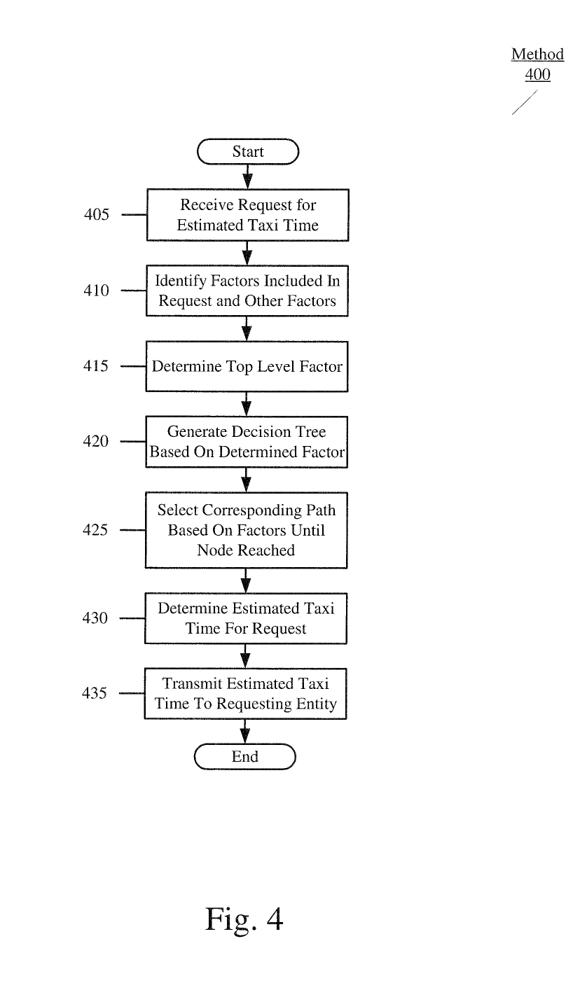

FIG. 4 shows an exemplary method 400 for predicting a taxi time duration for an aircraft and/or an airport according to the exemplary embodiments. As noted above, a request may have associated factors that are used in estimating a taxi time. By generating a decision tree (in a singular manner or as an overall decision tree based on a plurality of individual decision trees), a path may be traversed using the associated factors until a node is reached and the estimated taxi time is identified. Accordingly, the method 400 may be performed by the estimation server 125 from receiving input and data from the end user devices 105-115 and the data sources 135-140.

In 405, the estimation server 125 receives a request for an estimated taxi time from a requesting entity such as one of the end user devices 105-115. The request may include different types of information such as the identity of the requesting entity and other identification information. The request may also include factors that are associated with the estimating the taxi time. Thus, in 410, the estimation server 125 may identify the factors and any other factor included in the request. For example, the factors may include an expected landing time (or ON phase) on a particular day. The estimation server 125 may also determine other factors that may be associated with the request. For example, the other factors may include a runway that is to be used based on the expected landing time, a day of the week, a week of the year, a season, an expected weather condition, etc.

In 415, the estimation server 125 determines a top level factor. As described above, information entropy via the entropy engine 240 and the information gain via the gain engine 245 may identify an interdependency and how factors interact with one another. Accordingly, a degree by which each factor affects the estimating of the taxi time may also be determined. Thus, a factor that has a greatest effect on estimating the taxi time may be determined.

In 420, using the identified factors and the factor having the greatest effect, the estimation server 125 may generate a decision tree. In this decision tree, a highest level may be occupied by the top level factor. The top level factor may also have a threshold value associated therewith. Thus, with a binary decision tree, the corresponding factor value of the request may be compared to the top level factor and its corresponding threshold value for a match. In 425, the estimation server 125 may traverse a path based on the match determinations of the top level factor. For example, if a match is determined, a first path (e.g., right side) may be selected whereas if a match is not determined, a second path (e.g., left side) may be selected.

The estimation server 125 may repeat this process of generating the decision tree and selecting the proper path. For example, a first, lower level after the top level factor may be a node or another factor where the factor may have a next highest effect on estimating the taxi time along the respective branching path. In this manner, each lower level after the highest level may be occupied by a node or another factor. Furthermore, each lower level for each branching path may be occupied by different factors as the interdependency of the factors for these paths may have different combinations of factors that affect the taxi time. As for the nodes, the estimation server 125 may determine if the branching of the decision tree is to lead to a node based on a variety of criteria such as class distribution, number of samples, maximum tree depth, minimal error rate, etc. In generating the decision tree including the branches and nodes, the estimation server 125 may also utilize weighted decision trees that are incorporated into an overall decision tree. The weighting of the decision trees may affect, for example, the values indicated in the nodes so that a more accurate estimation of the taxi time may be provided by each node.

Once the path is traversed using the factors of the request until a node is reached, in 430, the estimation server 125 determines the estimated taxi time for the request as indicated in the node. Thereafter, in 435, the estimation server 125 transmits the estimated taxi time to the requesting entity that provided the request.

The exemplary embodiments describe a device, system, and method for estimating a time of arrival from a first position to a second position for an aircraft by generating a decision tree using an entropy based approach. Specifically, the exemplary embodiments may determine a taxi time from an ON phase to an IN phase. A request may have a plurality of factors associated therewith directly from the request or indirectly through other determinations or inputs. By generating the decision tree at least in part based on the factors and organizing the factors using information entropy and information gain as well as by aggregating weighted decision trees, a path may be traversed through the decision tree until a node identifying an estimated taxi time is determined.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the calculation engine may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
at an estimation server:
receiving a request to estimate a time of arrival for an aircraft from a first position to a second position, the request having a plurality of request values for factors associated with the request, the factors being characteristics associated with the time of arrival;
determining an interdependency among the factors based on information entropy and information gain, the information entropy indicating a disorder measurement in a historical data set corresponding to the factors, the information gain indicating a mutual measurement of the factors based on the historical data set;
generating a decision tree based on the factors and the interdependency, a first one of the factors being at a first, highest level of the decision tree, the first factor in the decision tree having a first threshold value, at least one second one of the factors being at a second, lower level of the decision tree, the second factor in the decision tree having a second threshold value; and
estimating the time of arrival based on traversing a path through the decision tree using the request values until a node is reached, the node indicated an estimated time of arrival.

2. The method of claim 1, wherein the factors comprise a time of a day, a day of a week, a week of a year, a precipitation amount, a temperature value, a visibility index, an actual number of other departing aircraft on a tarmac common with the aircraft, an expected number of other departing aircraft on the tarmac at a predicted arrival time, an actual number of other arriving aircraft on the tarmac, an expected number of arriving aircraft on the tarmac at the predicted arrival time, an arrival runway identification, an arrival fix value, a standard arrival route, an estimated departure clearance time, a scheduled time of departure, an arrival terminal, an arrival gate, a congestion value, and a combination thereof.

3. The method of claim 1, further comprising:
reducing the disorder measurement in the historical data set to determine an interaction among the factors and determine the information gain.

4. The method of claim 1, wherein the mutual measurement indicates a probability of one of the factors being associated with at least another one of the factors, the probability being further associated with the time of arrival.

5. The method of claim 1, wherein the mutual measurement identifies an accuracy measurement for each of the factors and combinations of the factors in estimating the time of arrival.

6. The method of claim 1, wherein the decision tree is a binary decision tree where factors in the decision tree split into two branches.

7. The method of claim 6, wherein each path capable of being traversed through the decision tree terminates at one of a plurality of nodes.

8. The method of claim 7, wherein each of the nodes is declared based on one of a class distribution, a number of samples, a maximum tree depth, a minimal error rate, or a combination thereof.

9. The method of claim 1, wherein the decision tree is generated using a random forest operation in which a plurality of decision sub-trees are aggregated, each sub-tree being unique and providing a respective perspective to estimate the time of arrival.

10. The method of claim 9, wherein the decision sub-trees are aggregated based on respective weights assigned to each decision sub-tree.

11. The method of claim 10, wherein each decision sub-tree selects randomly selected ones of the factors.

12. The method of claim 1, wherein the historical data set is from a government source, a private weather source, a radar location source, a past runway usage source, or a combination thereof.

13. The method of claim 1, wherein the time of arrival is a taxi time, the first position is an ON phase, and the second position is an IN phase.

14. An estimation server, comprising:
a transceiver configured to receive a request to estimate a time of arrival for an aircraft from a first position to a second position, the request having a plurality of request values for factors associated with the request, the factors being characteristics associated with the time of arrival, the transceiver also configured to receive a historical data set; and
a processor determining an interdependency among the factors based on information entropy and information gain, the information entropy indicating a disorder measurement in a historical data set corresponding to the factors, the information gain indicating a mutual measurement of the factors based on the historical data set, the processor generating a decision tree based on the factors and the interdependency, a first one of the factors being at a first, highest level of the decision tree, the first factor in the decision tree having a first threshold value, at least one second one of the factors being at a second, lower level of the decision tree, the second factor in the decision tree having a second threshold value, the processor estimating the time of arrival based on traversing a path through the decision tree using the request values until a node is reached, the node indicated an estimated time of arrival.

15. The estimation server of claim 14, wherein the factors comprise a time of a day, a day of a week, a week of a year, a precipitation amount, a temperature value, a visibility index, an actual number of other departing aircraft on a tarmac common with the aircraft, an expected number of other departing aircraft on the tarmac at a predicted arrival time, an actual number of other arriving aircraft on the tarmac, an expected number of arriving aircraft on the tarmac at the predicted arrival time, an arrival runway identification, an arrival fix value, a standard arrival route, an estimated departure clearance time, a scheduled time of departure, an arrival terminal, an arrival gate, a congestion value, and a combination thereof.

16. The estimation server of claim 14, wherein the decision tree is a binary decision tree where factors in the decision tree split into two branches.

17. The estimation server of claim 16, wherein each path capable of being traversed through the decision tree terminates at one of a plurality of nodes, each of the nodes being declared based on one of a class distribution, a number of samples, a maximum tree depth, a minimal error rate, or a combination thereof.

18. The estimation server of claim 14, wherein the decision tree is generated using a random forest operation in which a plurality of decision sub-trees are aggregated, each sub-tree being unique and providing a respective perspective to estimate the time of arrival.

19. The estimation server of claim 14, wherein the decision sub-trees are aggregated based on respective weights assigned to each decision sub-tree.

20. A non-transitory computer readable storage medium with an executable program stored thereon, wherein the program instructs a microprocessor to perform operations comprising:
receiving a request to estimate a time of arrival for an aircraft from a first position to a second position, the request having a plurality of request values for factors associated with the request, the factors being characteristics associated with the time of arrival;
determining an interdependency among the factors based on information entropy and information gain, the information entropy indicating a disorder measurement in a historical data set corresponding to the factors, the information gain indicating a mutual measurement of the factors based on the historical data set;
generating a decision tree based on the factors and the interdependency, a first one of the factors being at a first, highest level of the decision tree, the first factor in the decision tree having a first threshold value, at least one second one of the factors being at a second, lower level of the decision tree, the second factor in the decision tree having a second threshold value; and
estimating the time of arrival based on traversing a path through the decision tree using the request values until a node is reached, the node indicated an estimated time of arrival.
